(19) United States
(12) Patent Application Publication
(10) Pub. No.: US 2010/0132317 A1
(43) Pub. Date: Jun. 3, 2010

(54) DUST SEPARATOR

(76) Inventor: J. Philip Thien, Shorewood, WI (US)

Correspondence Address: GODFREY & KAHN S.C., 780 NORTH WATER STREET, MILWAUKEE, WI, 53202, US

(21) Appl. No.: 12/624,022

(22) Filed: Nov. 23, 2009

Related U.S. Application Data
(60) Provisional application No. 61/116,715, filed on Nov. 21, 2008.
(60) Provisional application No. 61/117,221, filed on Nov. 23, 2008.

(51) Int. Cl. B01D 45/08

(52) U.S. Cl. 55/368; 55/462

(57) ABSTRACT

A dust separator including an inlet, a baffle and an outlet. The baffle is disposed below the inlet and substantially parallel to an incoming air stream, and is shaped to allow the separated dust to fall below the baffle and prevent the separated dust below the baffle from re-entering the air stream. The baffle is preferably a generally circular shape with an arc-shaped slot, where the slot has a radius smaller than the radius of the balance of the baffle.

### CROSS-REFERENCE TO RELATED APPLICATIONS

This application is based upon and claims priority from Provisional Patent Application No. 61/116,715 filed on Nov. 21, 2008 and Provisional Patent Application No. 61/117,221 filed on Nov. 23, 2008, both of which are incorporated herein in their entireties for all purposes.

### BACKGROUND OF THE INVENTION

The present invention relates generally to dust separation and collection systems. Specifically, the present invention relates to an improved dust separation and collection system suitable for use in many applications.

Dust collectors are commonly used in production and home workshops to capture dust and other debris. They keep shops clean, while providing clean, breathable air. Many different types of dust collectors are available for use. In smaller production and home workshops, there is not room for a large dust collection system, so various attachments for the traditional shop vacuum or “shop vac” are generally used.

A shop vac can be attached directly to the tools to take in the saw dust created while using the tool. Because so much dust is created in woodworking, the filters in the shop vac are quickly clogged, causing the shop vac to lose suction and become ineffective. Bags are available to provide a first level of separation for the dust and other debris. The bags provide a longer effective time, but still fill up too quickly and are quite messy to change.

Other separator devices are also available for use with traditional shop vacs. One common type of separator can be fitted to the top of a five-gallon drum or other collection vessel. These separator devices are generally cyclone separators, which use the centrifugal forces of rotating air to throw the dust and debris to the outside walls of the separator where gravity then allows the dust and debris to fall into the collection vessel. One problem with these cyclone separator devices is that while the shop vac is running, the rotating air is constantly churning up the dust in the collection vessel that had already been separated. As a result, some of the collected dust is re-suspended in the air stream and ends up back in the shop vac, creating the same problems with efficiency and effectiveness.

This invention relates to improvements to the devices described above, and to solutions to some of the problems raised or not solved thereby.

### SUMMARY OF THE INVENTION

Accordingly, a need exists for an improved dust separation and collection system for use in connection with shop vacs and other operations. Of course, the present invention may be used in a multitude of situations where similar performance capabilities are required.

The present invention provides a dust separation and collection system. One embodiment of the present invention includes a collection vessel and a dust separator disposed on the collection vessel. The dust separator has a top portion, an inlet, an outlet and a baffle. The baffle is suspended below the top portion. It has a major dimension substantially equal to the dimension of the interior space of the collection vessel, and a slot having a dimension smaller than the major dimension. An air stream with entrained dust or debris enters the inlet, rotates about the interior space to separate the dust or debris therefrom, and exits through the outlet. The major dimension of the baffle prevents dust and debris from re-suspension into the air stream and the slot of the baffle allows dust and debris to fall into the collection vessel.

In one preferred embodiment, the major dimension of the baffle is an arc of a circle having a first radius and the slot dimension of the baffle is an arc of a circle having a second radius, wherein the second radius is shorter than the first radius. The second radius can be approximately one and one-eighth to one and one-quarter inches shorter than the first radius, and can extend around approximately two-thirds of the circumference of the baffle. A number of other configurations are also effective.

Another embodiment of the dust separation and collection system of the present invention includes a blower connected to a collection bag and a dust separator between the collection bag and the blower. The dust separator has an inlet that receives an air stream entrained with dust or debris from the blower, a baffle positioned below and parallel to the air stream entering through the inlet, and an outlet that exhausts the air stream. The inlet directs the air stream into a rotating path such that the dust and debris is separated from the air stream and free to fall into the collection bag. The baffle is shaped to allow the dust and debris to fall into the collection bag but prevent such dust and debris from re-entering the air stream.

The present invention also contemplates a dust separator, including an inlet, a baffle and an outlet. The inlet is positioned to deliver an air stream entrained with dust into a rotating path such that the dust is separated from the air stream. The baffle is disposed below the inlet and substantially parallel to the air stream, and is shaped to allow the separated dust to fall below the baffle and prevent the separated dust below the baffle from re-entering the air stream. The outlet exhausts the air stream, which has been substantially cleared of the entrained dust. The dust separator of the present invention can include a top portion that is substantially parallel with the baffle, from which the baffle is suspended. In the alternative, the dust separator can be of a circular cross-section in a ring or cylindrical shape. The baffle is preferably a generally circular shape with an arc-shaped slot.

The present invention has a number of advantages and addresses a long-felt but unsolved problem. The unique baffle of the present invention separates the majority of the dust and deposits it into the collection vessel or bag, keeping the exhausting air stream clean and the dust collection system efficient and effective. As a result, the problems associated with the prior art, including but not limited to clogged filters, quickly filled bags, and poorly cleaned exhaust air, are substantially eliminated.

### BRIEF DESCRIPTION OF THE DRAWINGS

FIG. 1 is a front view of one embodiment of the dust separation and collection system of the present invention;

FIG. 2 is a perspective view of one embodiment of the dust separator of the present invention;

FIG. 3 is a top plan view of one embodiment of a baffle of the present invention;

FIG. 4 is a perspective view of one embodiment of a dust separator of the present invention, shown installed in a traditional single-stage dust collector;

FIG. 5 is a bottom perspective view of the dust separator of FIG. 4;

FIG. 6 is a top perspective view of the dust separator of FIG. 4;

FIG. 7 is a front view of one embodiment of the dust separator of the present invention, using a tangential inlet.

### DETAILED DESCRIPTION OF THE PREFERRED EMBODIMENTS

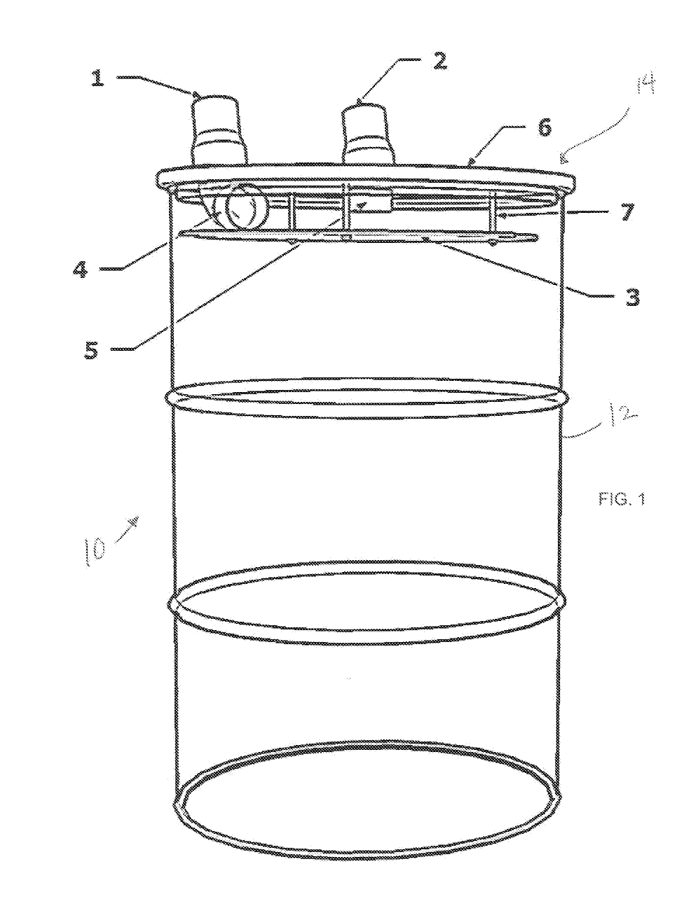

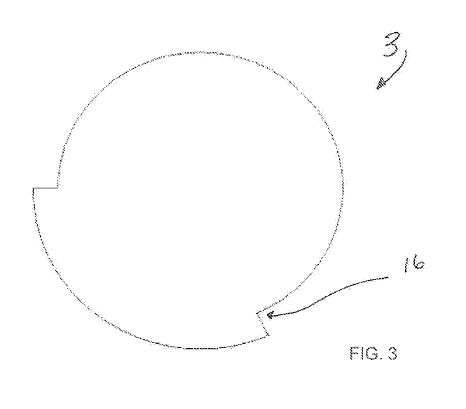

Referring now to the drawings, FIGS. 1-3 show a dust separation and collection system of the present invention. FIG. 1 shows a dust separation and collection system 10 including a collection vessel 12 and a dust separator 14. The collection vessel 12 can be of any variety, including a five-gallon drum, a trash receptacle, or the like. Vessels with a cylindrical shape or circular cross-section will work the best, though other shaped vessels could also be used. The dust separator 14 fits on the top of the collection vessel 12.

The dust separator 14 includes a top portion 6, an inlet 1, an outlet 2 and a baffle 3. The top portion 6 is sized to fit closely with top of the collection vessel 12, creating a generally air tight seal. It can be fastened to the collection vessel 12 using any appropriate fastening means, which are well known to those in the art. It can also be held in place by gravity and/or vacuum alone, without the use of fasteners. The fastening of the top portion 6 to the collection vessel 12 should be an easily removable fastening, so that the collection vessel 12 can be easily emptied.

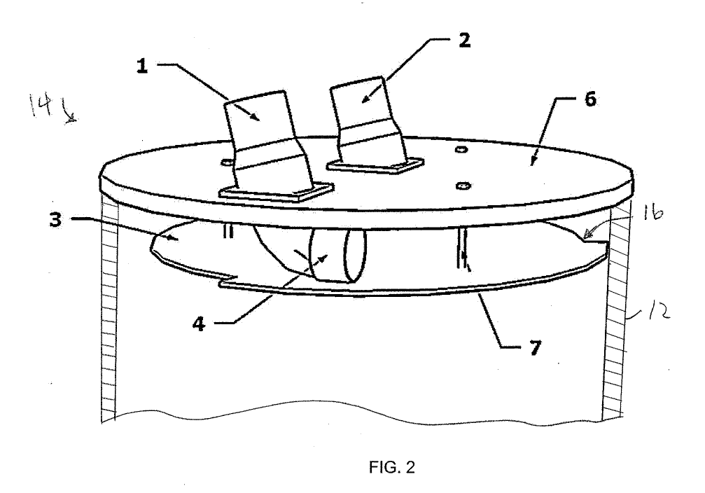

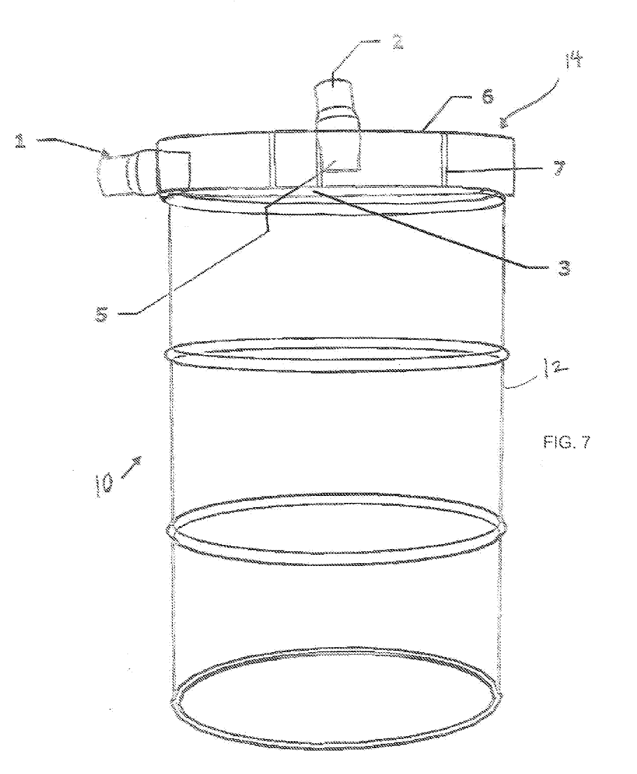

The inlet 1 accepts air from the shop vac or other source of incoming air. The dust separator 14 is preferably constructed so that the inlet 1 is placed near the outside of the top portion 6, extending down to the baffle 3. For ease of manufacturing, the inlet 1 can be arranged as shown in FIGS. 1-2, where the inlet 1 extends through the top portion 6. When arranged in this fashion, inlet 1 is usually oriented substantially perpendicular to, or at least at an angle passing through the top portion 6, and includes an elbow 4 to send the air into the collection vessel 12 in a direction substantially parallel to the top portion 6. The dust separator 14 can also be constructed so that the inlet 1 is placed more tangentially to the top portion 6. The more tangential placement of the inlet 1 increases the radius of the elbow, reducing the loss of velocity of the air as it travels through the elbow. A fully tangential placement of the inlet 1, as shown in FIG. 7, would eliminate the need for any elbow 4, and would be the most efficient and advantageous. It is also more effective to have the inlet 1 positioned such that the slot 16 (described in more detail below) of the baffle 3 is at the furthest point from the path of the incoming air.

The outlet 2, by which air passes through the top portion 6, is generally placed at or near the center of the top portion 6. The outlet includes a vortex finding tube 5, which extends into the rotating air beneath the top portion 6. The air at the center of the collection vessel 12, between the baffle 3 and the top portion 6, will be slower moving air. The air in that area has been substantially cleared of dust and debris, such that mostly clean air exits through the vortex finding tube 5 and the outlet 2.

The baffle 3 is suspended underneath the top portion 6, and is shaped to act as a barrier for the dust that has already been collected while still allowing the newly entering dust to fall through to the collection vessel 12. Any suitable type of suspension system may be used to suspend the baffle 3 from top portion 6, as one with skill in the art will readily understand. One preferred suspension system includes three connecting rods 7 extending between the top portion 6 and the baffle, as shown in FIGS. 1-2 and 7. Another alternative would be to form the baffle 3 integrally with the top portion 6. The distance between the top portion 6 and the baffle 3 can vary depending upon the particular application and type of vacuum system used. In general, it is desirable to keep the distance to a minimum, such that the baffle 3 would be positioned where the air stream enters the collection vessel 12, but other configurations are possible and effective.

The baffle 3 is comprised of a substantially flat member, and has a major dimension of a larger radius for part of its circumference, and a smaller, reduced radius for the balance of its circumference. The major or outside dimension is substantially equal to the inner radius or inner dimension of the collection vessel 12. The baffle 3 has a slot 16 formed by the difference between the inner dimension of the collection vessel and the reduced radius portion of the baffle. The slot 16 allows the dust and other debris to fall into the collection vessel 12. The slot 16 can be a number of different lengths, widths and radii depending on the material being separated, the size of the collection vessel and the air flow through the system. In one preferred embodiment for a system used in connection with wood saw dust and a traditional shop vac, a baffle 3 with a slot 16 that spans approximately 240° (or approximately two-thirds (⅔)) of the circumference of the baffle and has a radius that is one and one-eighth (1⅛) to one and one-quarter (1¼) inches shorter than the radius of the major dimension has been found to be very effective. Applications dealing with heavier dust or other debris will generally require a smaller slot 16 for maximum effectiveness. The slot sizes for lighter debris can vary depending on the type of material being separated. For example, in some applications, a slot width of only a few inches may be sufficient, or a reduction in radius of one and one-half (1½) inches or more may be required.

In operation, an incoming air stream with entrained dust or other debris is either pushed or pulled through inlet 1. The incoming air is directed into rotation about the inner wall of the collection vessel 12 as it leaves inlet 1. As the air rotates about the inside of the collection vessel 12, the velocity of the air stream slows and is no longer capable of keeping the dust and debris in suspension. Dust and debris is allowed to fall through the slot 16 of baffle 3, and settles to the bottom of the collection vessel 12. Substantially cleaned air exits via vortex finding tube 5 and outlet 2. As can be seen best in FIG. 2, the major radius of the baffle 3 is oriented to fall under the incoming air stream, protecting dust and debris that has already settled from re-suspension. The separation of the settled dust and debris from the rotating air stream prevents potential suction of the dust and debris back through the outlet, keeping the vacuum system clean, efficient and effective.

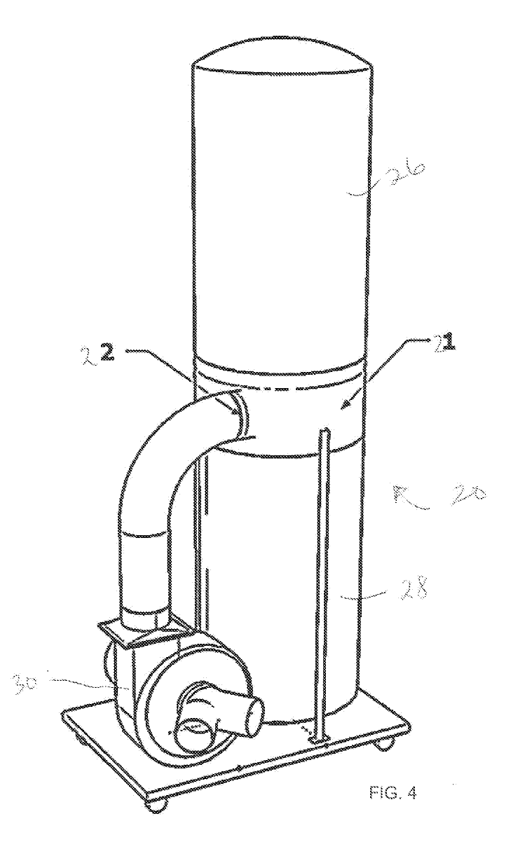

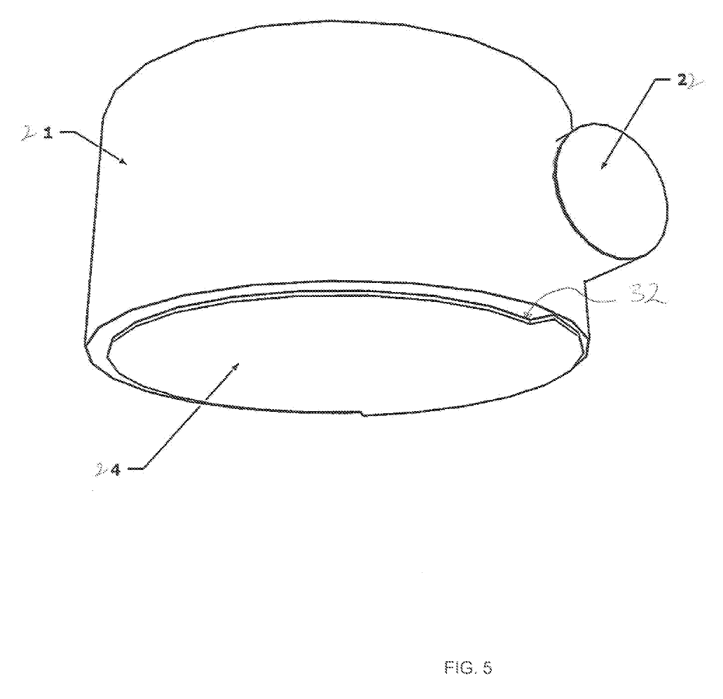

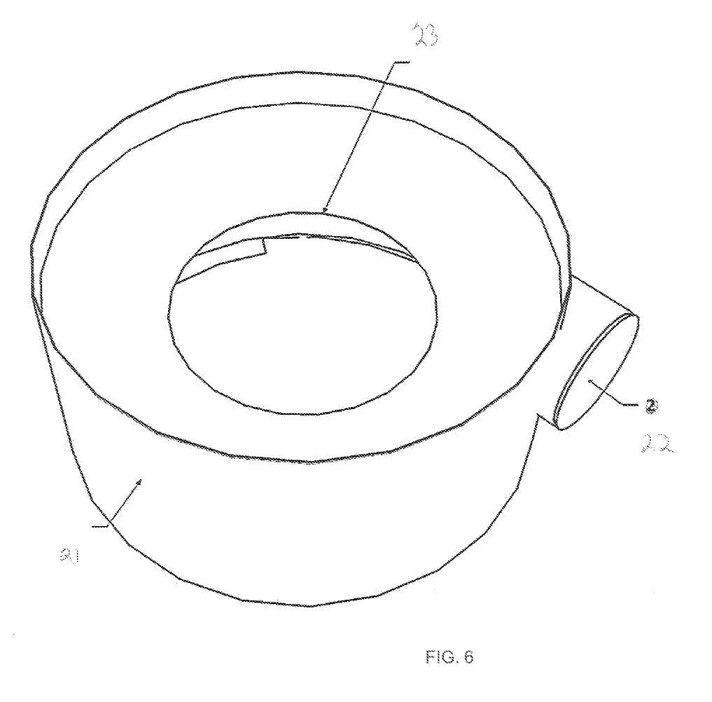

Another embodiment of the present invention is shown in FIGS. 4-6. A traditional single-stage dust collector includes a blower 30 connected to a bag 28 and filter 26. A dust separator ring 21 is disposed between the bag 28 and filter 26. The ring 21 includes a tangential inlet 22, an outlet hole 23 and a baffle 24. The baffle 24 has a major radius substantially equal to the inner radius of the ring 21, and a slot 32. The slot 32 has a radius that is reduced in length from the radius of the major dimension. A number of different slot sizes can be used, however, it has been found particularly effective for woodworking applications to use a slot that extends along two-thirds (⅔) of the circumference of the baffle 24 and has been reduced in radius by approximately one and one-eighth (1⅛) inches. The proportions of the baffle 24 may be adjusted to accommodate different separation target media. Both the reduction angle and scope may be adjusted depending on the target media's size and weight.

An incoming air stream from blower 30 with entrained dust or other debris enters through tangential inlet 22 and begins rotation. As the air rotates about the inside of the ring 21, the velocity of the air stream slows and is no longer capable of keeping the dust and debris in suspension. Dust and other debris is allowed to fall through the slot 32 of baffle 24, and settles to the bottom bag 28. Substantially cleaned air exits to the final filter stage 26 via outlet hole 23. The major radius of the baffle 24 is oriented to fall under the incoming air stream, protecting dust and debris that has already settled to the bottom bag 28 from re-suspension. When using the dust separator ring 21 including baffle 24 of the present invention, it is also possible to vent the outlet directly to the outside air, skipping the final filter stage, because the air is clean enough to vent to the outdoors.

The dust separation and collection system of the present invention can be used in a number of applications and in connection with a number of existing separation devices. For example, the present invention is quite effective for separating and collecting the sawdust created during woodworking operations for all different types of wood. The system has also been shown to be effective for separating flower petals from flowers. Hence, the term “dust” and the term “debris” as used herein are both intended to cover a broad range of media, including sawdust and other types of dust as well as bulky media like flower petals and any other media that can be effectively separated from air or other media using the present invention.

Although the invention has been herein shown and described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

I claim:

1. A dust separation and collection system comprising:
a collection vessel having an open top, a closed bottom and a wall, forming an interior space in the vessel;
a dust separator disposed on the collection vessel, the dust separator having a top portion, an inlet, an outlet and a baffle suspended below the top portion,
wherein the baffle has a perimeter, with a portion of the perimeter having a major dimension substantially equal to the dimension of the wall of the collection vessel, and portion of the perimeter with a dimension smaller than the major dimension, thereby forming a slot between the wall and that portion of the perimeter of the baffle having the smaller dimension;
wherein an air stream with entrained dust or debris enters the inlet, rotates about the interior space to separate the dust or debris therefrom, and exits through the outlet; and
wherein the major dimension of the baffle prevents dust and debris from re-suspension into the air stream and the slot of the baffle allows dust and debris to fall into the collection vessel.

2. The dust separation and collection system of claim 1, wherein the top portion is positioned on the open top of the collection vessel to create an air tight seal.

3. The dust separation and collection system of claim 1, wherein the major dimension of the baffle is an arc of a circle having a first radius and the slot dimension of the baffle is an arc of a circle having a second radius, wherein the second radius is shorter than the first radius.

4. The dust separation and collection system of claim 3, wherein the second radius is one and one-eighth to one and one-quarter inches shorter than the first radius.

5. The dust separation and collection system of claim 1, wherein the slot extends around two-thirds of the circumference of the baffle.

6. The dust separation and collection system of claim 1, wherein the inlet is substantially perpendicular to and passes through the top portion.

7. The dust separation and collection system of claim 1, wherein the inlet includes an elbow.

8. The dust separation and collection system of claim 1, wherein the inlet is substantially parallel to the top portion.

9. The dust separation and collection system of claim 1, wherein the inlet is shaped to deliver an incoming air stream between the top portion and the baffle in a direction substantially parallel to the top portion and baffle.

10. The dust separation and collection system of claim 1, wherein the outlet includes a vortex finding tube that extends to a point in between the top portion and the baffle.

11. The dust separation and collection system of claim 1, wherein the outlet is positioned in the center of the top portion.

12. A dust separation and collection system comprising:
a blower connected to a collection bag;
a dust separator between the collection bag and the blower, wherein the dust separator includes an inlet that receives an air stream entrained with dust or debris from the blower, a baffle positioned below and parallel to the air stream entering through the inlet, and an outlet that exhausts the air stream;
wherein the inlet directs the air stream into a rotating path such that the dust and debris is separated from the air stream and free to fall into the collection bag; and
wherein the baffle is shaped to allow the dust and debris to fall into the collection bag but prevent such dust and debris from re-entering the air stream.

13. The dust separation and collection system of claim 12, wherein the dust separator has a circular cross-section and the inlet is positioned tangentially with respect to said circular cross-section.

14. The dust separation and collection system of claim 12, wherein the outlet exhausts to a filter.

15. The dust separation and collection system of claim 12, wherein the outlet exhausts to the outdoors.

16. A dust separator comprising:
an inlet positioned to deliver an air stream entrained with dust into a rotating path such that the dust is separated from the air stream;
a baffle disposed below the inlet and substantially parallel to the air stream, wherein the baffle is shaped to allow the separated dust to fall below the baffle and prevent the separated dust below the baffle from re-entering the air stream; and
an outlet for exhausting the air stream, which has been substantially cleared of the entrained dust.

17. The dust separator of claim 16, wherein the baffle is suspended from a top portion.

18. The dust separator of claim 16, wherein the baffle is positioned within a supporting ring.

19. The dust separator of claim 16, wherein the baffle is a generally circular shape with an arc-shaped slot, the slot having a radius smaller than the radius of baffle.

20. The dust separator of claim 19, wherein the slot extends approximately 240° of the circumference of the baffle.
